(19) United States
(12) Patent Application Publication
(10) Pub. No.: US 2003/0233731 A1
(43) Pub. Date: Dec. 25, 2003

(54) Hinge cover

(76) Inventor: Oren Cotton, East Sound, WA (US)

Correspondence Address: Andrew W. Ludy, 17 Sherwood Way, Landing, NJ, 07850, US

(21) Appl. No.: 10/175,436

(22) Filed: Jun. 19, 2002

(51) Int. Cl. E05D 11/00

(52) U.S. Cl. 16/250

(57) ABSTRACT

A hinge cover is for use in connection with a hinge having a pivotal axis and typically two leaves penetrated by fasteners with heads. The hinge cover comprises a plate covering the leaf. The plate is attached either to the hinge or to the fastener heads with an adhesive pad having a pressure-sensitive adhesive surface. The plate has a skirt projecting outward from the plate lower surface, so as to cover the leaf edges and the leaf distal end.

### FIELD OF THE INVENTION

This invention relates to the field of hinges, and more particularly to a hinge leaf cover for covering the hinge leaf, and hiding from view fasteners used to attach the hinge.

### BACKGROUND OF THE INVENTION

Hinges are used in a wide variety of applications, including high end products wherein attractive appearance is paramount. The heads of fasteners, such as screws, present an unsightly appearance for such products. Certain consumer product applications have safety requirements, as well. Heads of screws may have burrs and sharp edges projecting outward. Such burrs and edges can splinter or cut a hand or foot placed thereupon. This is a consideration on a boat, where people often walk on deck barefoot. Another problem with such exposed fasteners is security. They can easily be loosened to gain access to a locked compartment. Of paramount importance in manufacturing a product is fast and easy assembly of the parts using unskilled labor and no assembly components or tools.

One solution to these problems is to cover the hinge leaf with a plate. Such covers are known, and have taken a variety of configurations. Some hinge covers in the prior art are shown in the following patents:

Chung, WO 99/18316, discloses a cover plate that slides upward into grooves in the leaf when the door is partially open. In the fully open or closed position, the cover cannot be removed because the lower leaf closes off the end of one groove.

Brotschi, EP 0 259 618, employs a cover plate with screws to secure the leaf to a base plate.

Pacini, EP 0 387 207, shows a cover plate, one edge of which is inserted into a groove in the leaf, and the other edge snaps down into another groove. A projecting tab on the plate inner surface fits between two mounting screws to prevent sliding the cover off.

Robins, GB 2 262 119, teaches a security lock mounted in a hinge leaf, which is attached to an access door. A cover plate keeps dirt and water out of the lock. The cover pivots on the hinge axis and is secured by a releasable latch.

Toldo, U.S. Pat. No. 3,768,117, discloses a cover integral with the leaf, joined thereto by a flexible hinge along one edge. The opposite edge has a snap closure.

Toldo, U.S. Pat. No. 3,665,552, discloses a cover similar to the above invention, with a central snap closure tab.

Beyer, DE 197 57 213, depicts a cover, engaging a hole in the hinge leaf by means of a hook.

Sinsteden, EP 0 824 177, shows a hinge with leaves and having covers set into pockets in the leaves.

Hernandez, U.S. Pat. No. 5,520,479, discloses a hinged locking hasp with leaves and a cover, in the form of a box, welded to a post.

MacIntyre, U.S. Pat. No. 5,339,493, discloses a hinge leaf mounted to a cover plate for adjustment with screws. The cover plate is mounted on the door with screws.

Allen, U.S. Pat. No. 4,656,691, shows a hinge leaf that doubles back upon itself to form a pocket, into which the cover is inserted with the door open. Closing the door prevents the cover from being removed.

Kraemer, EP 1 067 266, teaches a cover sliding into grooves in a hinge leaf. Assembling the leaves together holds the cover in place.

Lueffe, EP 0 987 393, discloses a hinge leaf adjustable between an inner plate and an outer cover plate. Screws fasten the cover plate and inner plate to the door jamb.

None of the above-described inventions having a separate cover employs a skirt around the cover to shield the edge of the leaf and to shed water. In none of the prior art inventions is the cover attached with an adhesive. Brotschi, MacIntyre, and Lueffe attach the cover to the leaf with screws. Pacini, Toldo, and Beyer use snaps or hooks to attach the cover to the leaf. Chung, Pacini, Sinsteden, MacIntyre, and Kraemer require pockets or grooves in the leaf to mount the cover to the leaf.

Accordingly, there is a need to provide a cover for a hinge leaf that will provide fast and easy assembly of the cover to the leaf.

There is a further need to provide a cover of the type described and that will hide fastener heads from view, and show an attractive finished surface.

There is a yet further need to provide a cover of the type described and that will shield burrs and sharp edges for safety.

There is a still further need to provide a cover of the type described and that will provide a measure of security for locked compartments.

There is an additional need to provide a cover of the type described and that can be manufactured cost-effectively in large quantities of high quality.

### SUMMARY OF THE INVENTION

In accordance with the present invention, there is provided a hinge cover, for use in connection with a hinge assembly. The hinge has a pivotal axis and at least one leaf. The hinge assembly includes the hinge and at least one fastener penetrating the leaf The fastener has a head. The hinge cover comprises a plate covering the leaf and the fastener head. The plate has a skirt projecting outward from the plate lower surface so as to cover the leaf edges. The plate is attached to the hinge assembly with an adhesive. The plate is attached typically to the hinge leaf, but may be attached to the fastener head.

### BRIEF DESCRIPTION OF THE DRAWING

A more complete understanding of the present invention may be obtained from consideration of the following description in conjunction with the drawing, in which:

FIG. 1 is a top view of a hinge cover constructed in accordance with the invention;

FIG. 2 is an end view of the hinge cover of FIG. 1;

FIG. 3 is a bottom view of the hinge cover of FIG. 1;

FIG. 4 is a cross-sectional side view of the hinge cover of FIG. 1, taken along lines 4-4 of FIG. 1; and

FIG. 5 is an exploded perspective view of a hinge showing fasteners penetrating both leaves, and with the hinge cover of FIG. 1 installed on one leaf, and the hinge cover of FIG. 1 juxtaposed over the other leaf.

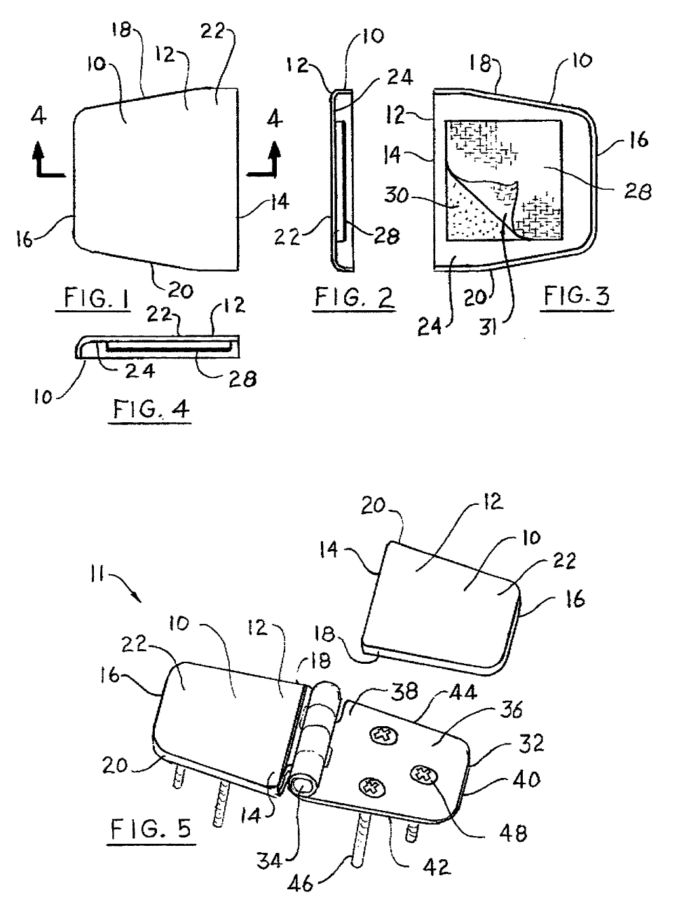

### DESCRIPTION OF THE PREFERRED EMBODIMENTS

Referring now to the drawing, a hinge cover 10 is for use in connection with a hinge assembly 11. The assembly includes a hinge 32, and at least one fastener 46. The hinge 32 has a pivotal axis 34 and at least one leaf 36, and typically two leaves 36, as shown in FIG. 5. Each leaf 36 extends between a proximal end 38 adjacent the pivotal axis 34 and a distal end 40. The leaf 36 extends between opposite right 42 and left 44 edges. The leaf 36 is penetrated by at least one fastener 46, and typically by several fasteners 46, as shown. The fastener 46 is typically a screw or a bolt having a head 48.

The hinge cover 10 comprises a plate 12 extending between opposite first 14 and second 16 ends. The plate 12 extends between opposite right 18 and left 20 edges. The plate 12 has opposite upper 22 and lower surfaces 24. The plate 12 covers the leaf 36 and the fastener head 48. The plate first end 14 is juxtaposed with the leaf proximal end 38. The plate second end 16 is juxtaposed with the leaf distal end 40. The plate right 18 and left 20 edges are juxtaposed with the leaf right 42 and left 44 edges respectively. The plate 12 has a skirt 26 extending along the plate right 18 and left 20 edges and the plate second end 16. The skirt 26 projects outward from the plate lower surface 24, so as to cover the leaf right 42 and left 44 edges and the leaf distal end 40, and to allow water to drain from between the leaf 36 and the plate 12, and also to make it difficult to pry the hinge cover off with a screwdriver or a knife. The plate 12 typically is made from stainless steel, or molded from plastic.

An adhesive is provided for attaching the plate 12 to the leaf 36. Alternatively, the plate 12 can be attached to the fastener head 48. The adhesive includes a pad 28 attached to the plate lower surface 24. The pad 28 has a pressure-sensitive adhesive surface 30. Typically, the pressure-sensitive adhesive surface 30 will include a peel-off layer 31 to protect the adhesive.

In practice, the hinge 32 is mounted in place with the fasteners 46. The peel-off layer 31 is removed, and the hinge cover 10 is positioned over the leaf 36. Downward force is then applied to secure the hinge cover 10 to the leaf 36 with the adhesive pad 28. A hinge covering method is disclosed for covering the hinge 32. The method comprises the steps of covering the hinge assembly with a plate, providing an adhesive, and attaching the plate to the hinge assembly with the adhesive. The next step includes attaching the plate 12 to the leaf 36 with the adhesive. Further steps include providing a pad 28 with a pressure-sensitive adhesive surface 30, attaching the pad to the plate lower surface 24, and attaching the plate 12 to the leaf 36 with the pad 28.

An alternative step comprises attaching the plate 12 to the fastener head 48 with the adhesive. The following steps comprise providing a pad 28 with a pressure-sensitive adhesive surface 30, attaching the pad 28 to the plate lower surface, and attaching the plate 12 to the fastener head 48 with the pad 28. Yet additional steps include projecting a skirt 26 outward from a lower surface 24 of the plate 12, covering an edge of the leaf 36 with the skirt 26, and allowing water to drain from between the leaf 36 and the plate 12.

Numerous modifications and alternative embodiments of the invention will be apparent to those skilled in the art in view of the foregoing description. Accordingly, this description is to be construed as illustrative only and is for the purpose of teaching those skilled in the art the best mode of carrying out the invention. Details of the structure may be varied substantially without departing from the spirit of the invention and the exclusive use of all modifications that will come within the scope of the appended claims is reserved.

The embodiments of the invention in which an exclusive property or privilege is claimed are defined as follows:

1. A hinge cover, for use in connection with a hinge assembly, the hinge having a pivotal axis and at least one leaf, the hinge assembly including the hinge and at least one fastener penetrating the leaf, the fastener having a head, the hinge cover comprising:
(a) a plate covering the leaf and the fastener head; and
(b) an adhesive on the plate for attaching the plate to the hinge assembly.

2. The hinge cover of claim 1, wherein the plate is attached to the hinge.

3. The hinge cover of claim 1, wherein the plate is attached to the fastener head.

4. A hinge cover, for use in connection with a hinge assembly, the hinge having a pivotal axis and at least one leaf, the leaf extending between a proximal end adjacent the pivotal axis and a distal end, the leaf extending between opposite right and left edges, the hinge assembly including the hinge and at least one fastener penetrating the leaf, the fastener having a head, the hinge cover comprising:
(a) a plate extending between opposite first and second ends, the plate extending between opposite right and left edges, the plate having opposite upper and lower surfaces, the plate covering the leaf and the fastener head, the plate first end juxtaposed with the leaf proximal end, the plate second end juxtaposed with the leaf distal end, the plate right and left edges juxtaposed with the leaf right and left edges, respectively; and
(b) an adhesive on the plate lower surface for attaching the plate to the leaf.

5. The hinge cover of claim 4, wherein the plate further comprises a skirt extending along the plate right and left edges and the plate second end, the skirt projecting outward from the plate lower surface, so as to cover the leaf right and left edges and the leaf distal end, and to allow water to drain from between the leaf and the plate.

6. The hinge cover of claim 5, wherein the adhesive includes a pad attached to the plate lower surface, the pad having a pressure-sensitive adhesive surface.

7. The hinge cover of claim 6, wherein the pad includes a peel-off layer attached to the pressure-sensitive adhesive surface, so that the peel-off layer will be removed, the hinge cover will be positioned over the leaf, and downward force will be applied to secure the hinge cover to the leaf with the adhesive pad.

8. A hinge covering method for covering a hinge assembly, the hinge having a pivotal axis and at least one leaf, the hinge assembly including the hinge and at least one fastener penetrating the leaf, the fastener having a head, the method comprising the steps of:
(a) covering the hinge assembly with a plate;
(b) providing an adhesive; and
(c) attaching the plate to the hinge assembly with the adhesive.

9. The hinge covering method of claim 8, further comprising the step of attaching the plate to the leaf with the adhesive.

10. The hinge covering method of claim 9, further comprising the steps of:
(a) providing a pad with a pressure-sensitive adhesive surface;
(b) attaching the pad to the plate lower surface; and
(c) attaching the plate to the leaf with the pad.

11. The hinge covering method of claim 8, further comprising the step of attaching the plate to the fastener head with the adhesive.

12. The hinge covering method of claim 11, further comprising the steps of:
(a) providing a pad with a pressure-sensitive adhesive surface;
(b) attaching the pad to the plate lower surface; and
(c) attaching the plate to the fastener head with the pad.

13. The hinge covering method of claim 10, further comprising the steps of:
(a) projecting a skirt outward from a lower surface of the plate;
(b) covering an edge of the leaf with the skirt; and
(c) allowing water to drain from between the leaf and the plate.
